(19) United States
(12) Patent Application Publication
(10) Pub. No.: US 2016/0078781 A1
(43) Pub. Date: Mar. 17, 2016

(54) Systems and Methods for Incentivizing Healthy Behavioral Changes with Evidence-Based Techniques and Tangible Rewards

(71) Applicant: Richard L. McCartney, BEDFORD, MA (US)

(72) Inventor: Richard L. McCartney, BEDFORD, MA (US)

(21) Appl. No.: 14/855,361

(22) Filed: Sep. 15, 2015

Related U.S. Application Data
(60) Provisional application No. 62/050,733, filed on Sep. 15, 2014.

(51) Int. Cl. G09B 19/00

(52) U.S. Cl. CPC G09B 19/00

(57) ABSTRACT

Systems and methods for incentivizing healthy behaviors and behavioral choices, and monitoring health behaviors, are provided. The present invention requests information for a user, evaluating the user's current health, and requiring the user to choose behaviors to modify through incentives. The behaviors are incentivized by implementing proven token economy concepts to reward desired behavioral choices and reward avoidance of undesired behavioral choices. The present invention provides suitable positive health choices. The rewards provided are tangible real-world rewards with monetary value. The systems and methods reinforce continued use by a user and lead to positive behavioral change.

### FIELD OF THE INVENTION

The presently disclosed subject matter relates to systems and methods for monitoring health behaviors and incentivizing desired changes, and more specifically, to systems and methods for offering tangible rewards with recognized monetary value in exchange for a person engaging in a desired act or behavior or avoiding an undesired act or behavior.

### BACKGROUND OF THE INVENTION

It is widely recognized that health outcomes depend on individual health choices, made daily throughout lifetimes. Health promotion can help support creation of healthy behaviors and habits for healthy choices. Health promotion is a social science focused on behavior. It draws on medical, psychological, and biological sciences, among others, to promote health of individuals. Health promotion focuses on voluntary changes to behavior and habits, with the goal of improving individuals' understanding of health outcomes and how their choices contribute to their health, and with the goal of positive change in habits and health outcomes. The benefits of healthy behaviors and improved health outcomes accrue to the individuals whose lives are improved and whose health care expenses are reduced, and also to insurers, employers and other providers of health care services, and society at large. Research has demonstrated that goals for health behavior changes are easier to achieve when they are specific and when there are not too many goals. Research has also shown that having a goal is not enough: individuals also need practical steps to achieve that goal.

Current approaches to health promotion include extensive consultations and education with trained professionals, which can be effective—but while face-to-face appointments are often necessary for the delivery of comprehensive care, they are time-intensive and therefore costly. Technological approaches to health promotion systems exist, but the current are has multiple shortcomings. Existing health promotion systems, whether run as software for desktop computers, internet (cloud-based) software-as-a-service (“SaaS”), or mobile apps, whether standalone or connected to a server, primarily use monitoring and projections of improved future health as motivators for change. Often, people start using these technological approaches to health promotion, experience a temporary movement towards established goals, and gradually decrease use of the health promotion system, resulting in user attrition from the health promotion system. Accordingly, for most users, performance of the desired change in health behavior decreases over time. Some contributing factors to discontinuation include time required to track behaviors, ineffective motivators for continued use (including punitive measures and/or non-tangible rewards), and lack of data proven protocols for making behavioral change. Tangible, as used throughout this disclosure of the present invention and the background thereto, specifically means rewards that have monetary value or that can be directly translated or converted into points that do have such monetary value.

In many such technological approaches to health promotion, the reward systems offered to users aren't effective. Some of such technological approaches to health promotion operate like games, under what is at times referred to as the gamification of health. In the gamification of health, a reward system may offer non-tangible “points” or “virtual points”, or adding non-tangible capabilities to a user's avatar or player, such as weapons, tools, skills, or badges, which only have significance within that game or network. While reward systems such as these may be sufficient to encourage some users to make positive health choices and form healthier habits, they do not appear to be sufficient to appeal to the general population, as not everyone wants to play video or app games, and even among those who do, not all will want to play health-related games.

Some technological approaches to health promotion operate on one or more social-media platforms, or create their own social media platform, where other users of the service can see the progress of a given user, and may also be able to comment on a user's progress or healthy choices and/or express encouragement to a user. While this likely provides the user satisfaction, it does not provide tangible rewards. Furthermore, such a technological approach to health promotion cannot work with users who are not on social media, or with users of social media who do not want to share health choices with the groups or community of people with whom they're connected on one or more social media platforms.

Another technological approach to health promotion entails people pooling money to have a pot, and winner(s) take the pot—but this approach will not succeed with people who cannot or do not want to find a group and create such a pool.

Yet another technological approach to health promotion involves an employer setting rewards. Shortcomings with this approach include, first, that the rewards then can't be customized to each user, second, that the rewards chosen by employers are often not monetary or tangible, and third, that increasingly, people work for small businesses or in entrepreneurial environments that cannot support the expenditure of employer-sponsored awards. People are known to respond more strongly to rewards that they have chosen themselves, and to monetary or tangible rewards.

Additionally, the current art of health promotion does not allow customization of incentive systems to each user, or to each user's desired behavioral change. Further, the current art does not properly choose levels of rewards that are appropriate to the positive behaviors that the user desires to undertake, and that should be properly incentivized. Additionally, the current art does not adequately weight rewards based on the means of data entry (which implies different levels of reliability or trustworthiness of the entered data), nor does it account for the value of time spent pursuing healthy behaviors increasing up to a point, and then leveling off or decreasing per unit time spent.

The current art of health promotion or behavior modification systems and methods have not been successful in helping large numbers of people to modify their behaviors. This relative lack of success at creating positive behavioral changes, such as stopping use of tobacco products, or helping people to lose weight and lower their body fat percentage or cholesterol, indicated that better technological approaches to health promotion are urgently needed. For instance, in the example of use of tobacco, the known negative health effects of smoking have been widespread for over 50 years. Despite near-universal knowledge of the adverse health outcomes from use of tobacco products, the number of users of these products has remained high, with recent studies showing nearly 27% of adults using tobacco products. People who use tobacco products typically use them daily, multiple times a day. The interplay of physical cravings, behavioral habits surrounding use, and integration into daily life make this an appropriate target for a health promotion system and methods that can be readily accessible, are easy to use, and can administer reinforcing tokens which represent rewards immediately.

In addition, the current art of technological approaches to health promotion are not easy enough to use, and do not capture data from multiple sources, and present it simply to the user. Finally, the current art does not present data in a simple and attractive way, or allow export of data to share with user's doctors and other health professionals.

### SUMMARY OF THE INVENTION

The present invention meets all these needs, by disclosing systems and methods for technological approaches to health promotion that solve the problems of only monitoring and making projections, user attrition, ineffective reward systems, including lack of choice of tangible rewards customizable to the desired behavioral change, lack of relevance of the rewards offered to the healthy behavior to be promoted, lack of adequate scale of the rewards to the health choices made by the user, accessibility to all users, ease of use and simplicity of entry of user data on health choices, integration with data sources and presentation of data to the user and desired health professionals.

At a high level of summary, the present invention may be implemented as a mobile-capable software application that incorporates successful evidence-based methods, informed by research and clinical expertise, to produce healthy behavior change in individuals and thus in the general health of society. Such evidence-based methods have been shown to work well with a variety of behaviors and populations, being studied by Ayllon and Azrin over the past 5 decades, and incorporated extensively into Community Reinforcement therapies.

The presently disclosed invention addresses the shortcomings in the current art by using established evidenced based techniques for successfully modifying behaviors and real-world, tangible rewards with recognized monetary value. Specifically, the present invention implements proven token economy concepts to positively reward desired healthy behaviors with rewards of actual monetary value, a key aspect in evidence-based behavioral change techniques. The present invention offers effective rewards systems by offering users a choice of rewards, which may be points administered by various retailers and corporations, including but not limited to airline miles, frequent-shopper rewards points, or credit card reward points. The user will have the ability to choose the specific form of rewards, and points will be given systematically to reinforce desired behaviors. Rewards may also be distributed to users as cash transfers, checks, electronic funds transfer, account credits applied to credit cards or other accounts, or distributed in other forms.

Furthermore, the present invention can be used to solve the problem of lack of customization of reward amounts, and the problem of customizing the rewards to a user's desired behavioral change, with a lack of proportionality between the behavioral choice that leads to a reward, and the scale of the reward in relation to the health behavior that the user is trying to change. The present invention does this by initially take the user through an exploration of values and health goals for the user's life, including a survey of health behaviors and level of satisfaction with several aspects of the user's life, such aspects including but not limited to health, education, income, social relationships, personal fulfillment, enjoyment, smiling, laughing, or feeling well-rested, as described further below. In this way and others, as will become clear, the present invention is designed to reinforce continued use of the applications, and reward desired behaviors, from the first time the user makes use of the present invention.

As a mid-level overview of the present invention, the presently disclosed invention facilitates two parallel processes simultaneously, keeping the rewards offered relevant to the healthy behavior to be promoted, and making the scale of the rewards proportional to the health choices made by the user, while making the system accessible to all users, and still keeping it easy to use by making entry of user data on health choices simple. First, the user is prompted to provide specific responses at different points in time about their behaviors and relevant health choices. Additionally, the system periodically presents the user with occasional opportunities, including but not limited to exploring literature, or entering information on customized health behaviors. By offering multiple opportunities to update the health screening tools, and reinforcing these tasks with rewards, the present invention provides longitudinal data and allows the user and the invented system to track a user's progress over time.

To choose levels of rewards that are appropriate to the positive behaviors that the user wants to carry out, the present invention determines the most stimulating aspects of the undesired behavior that the user wants to change, and assigns appropriate rewards to positive behaviors that replace or preclude that undesired behavior. The levels or quantities of the rewards assigned by the present invention are chosen to be sufficient to incentivize the user to choose and reinforce the positive behaviors as replacements for the undesired behaviors. Examples of such positive behaviors include finding beautiful scenery or other people to talk to, rather than smoking or snacking. The present invention focuses on reinforcing positive behaviors, because research has shown that positive behaviors can compete with and extinguish the undesired behavior. While it is likely that a user will find additional means to reinforce positive health behaviors, any such means are difficult to predict or standardize. Accordingly, the present invention incorporates a level of reinforcement that is sufficient to increase the frequency of the desired behavior. A “positive health choice”, as the term is used throughout this invention disclosure and description, can include a broad range of behaviors or acts that enhance or improve a user's health, or which do not detract from a user's health. Positive health choices can include, but are not limited to, engaging in healthy activities, or avoiding unhealthy ones; interacting with a software application (a mobile app, an internet-based app, or other); reading emails, messages, reports, and other information; using a social media platform to share a user's acts, or avoidance of acts; and making healthy purchases at retail, online, or of food.

The present invention also can address the shortcoming in the prior art related to the reliability of the entered data on a positive behavior, depending on the means used to enter that data. The present invention can set the “weighting” or amount of the reward for a particular positive behavior depending on how the behavior is measured. For instance, manual entry of data on a positive behavior may be the least weighted means of entering data on a positive behavior, while a means of data entry that is measured by a device that does not synchronize or share data with the inventive system is weighted more strongly. Data on positive behaviors that is directly measured with a device that shares data with the inventive system is most heavily weighted. By way of example, without limiting the foregoing, for dietary intake, manual data entry would be given the least weighting; submitting pictures of a meal or receipts for groceries, or scanning the barcode of an item, will be given relatively more weighting, and data from a swallow/chew wearable device that can directly share data with the inventive system will be weighted most heavily. Another example of weighting of rewards levels for positive behaviors based on the means of data entry includes, for the case of exercise, manual entry of data; a pedometer or other motion-tracking wearable or portable device that is not capable of synchronization, and a pedometer or other motion-tracking wearable or portable device that is capable of synchronization with the present invention. Other examples may include glucometers, heart rate monitors, respiratory monitors, breathalyzers and other blood-alcohol content monitors, and more.

Another problem in the prior art that is improved by the present invention is accounting for the value of time spent pursuing healthy behaviors increasing up to a point, and then leveling off or decreasing per unit time spent. The present invention presents methods to account for the increasing value of time spent pursuing positive behaviors up to some threshold or cut-off point, after which the positive benefit of that time levels off or declines. The weighting of the reward structure reflects this observation. The research-driven rationale for this incentive structure is that after some quantifiable time spend in a beneficial activity, the benefits of continuing the activity at that time can start to drop off significantly for any of a few reasons, including but not limited to: the person may already have built a healthy habit; the health benefits of, for instance, 70 minutes running as opposed to 60 minutes running are far less substantial than the benefits of 10 minutes as opposed to 0, or 20 minutes as opposed to 10; and the per minute reward becomes a smaller percentage of the positive health choice as total time increases. It is important to note that this proportional approach to reinforcement does not kick in before a threshold or cut-off point is reached, for instance at 1 hour of exercise, because the present invention seeks to more heavily reward early gains in positive health choices. For instance, in the example of exercise, increases in time exercising is most difficult in the 0 to 60 minute range, especially for people building new habits.

In the present invention, the systems that carry out the methods disclosed herein comprise a plurality of processors, a plurality of memory units, a plurality of input and output channels for communication, a plurality of databases, a plurality of networks which may be solely internal or may include the Internet, optionally a plurality of displays, and the ability to communicate with a plurality of user devices, including receiving information from such user devices, sending information to such user devices, and optionally monitoring and processing location data and other data from such user devices. The interactions of the system components with each other and the ways in which they carry out the methods of the present invention are described below in greater detail.

As noted above, current systems and methods of health promotion have not been successful at helping large numbers of people to modify their behaviors, such as stopping use of tobacco products, or losing weight. To apply the present invention to reduction or cessation in smoking or use of other tobacco products, for example, the inventive system and methods will build on the initial evaluation of health behaviors, values, and obstacles to modifying the user's behaviors, by identifying the desirable aspects of tobacco use. The present invention is simpler to use than current art, allowing communication with a range of existing health applications and mobile-enabled devices. The present invention also can present data on a user's health choices and behavior in a simple-to-understand and attractive manner, unlike current art, and can export a user's data to one or more of a user's chosen health professionals, to incorporate the user's data into the user's medical record, allowing for the user's health choices to inform their treatment plan.

These aspects of the present invention, and other disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but, the presently disclosed subject matter is not limited to the specific methods and instrumentalities disclosed. In the drawings, like reference characters generally refer to the same components or steps of the system or method throughout the different figures. In the following detailed description, various embodiments of the present invention are described with reference to the following drawings, in which:

FIG. 1 shows an exemplary method of incentivizing healthy behavioral changes with evidence-based techniques and tangible rewards from the perspective of the inventive system.

FIG. 2 shows an exemplary method of incentivizing healthy behavioral changes with evidence-based techniques and tangible rewards from the perspective of a user device.

FIG. 3 shows an exemplary method of incentivizing healthy behavioral changes with evidence-based techniques and tangible rewards from the perspective of a third party external to inventive system and a user device.

FIG. 4 illustrates a representative embodiment of the system of the present invention, depicting components of the inventive system, and elements external to such components.

### DETAILED DESCRIPTION

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The present subject matter discloses systems and methods for incentivizing healthy behavioral changes with evidence-based techniques and tangible rewards, by modifying behavior in a user from an unhealthy behavior to a desired alternative behavior, incentivized with tangible rewards for incremental behavioral modifications. The inventive systems and methods of health promotion use tangible rewards, which may be monetary or may be awards-points or loyalty points, including but not limited to frequent-flier miles, credit-card reward system points, or store loyalty points; furthermore, such rewards may be distributed to users as cash transfers, checks, electronic funds transfer, account credits applied to credit cards or other accounts, or distributed in other forms. These tangible rewards exclude rewards systems which are i) virtual points that cannot be converted to monetary rewards or equivalents, ii) social-media based, iii) users pooling money to form a pot to split, or iv) employer-set rewards. The inventive methods may be stored in computer-readable media.

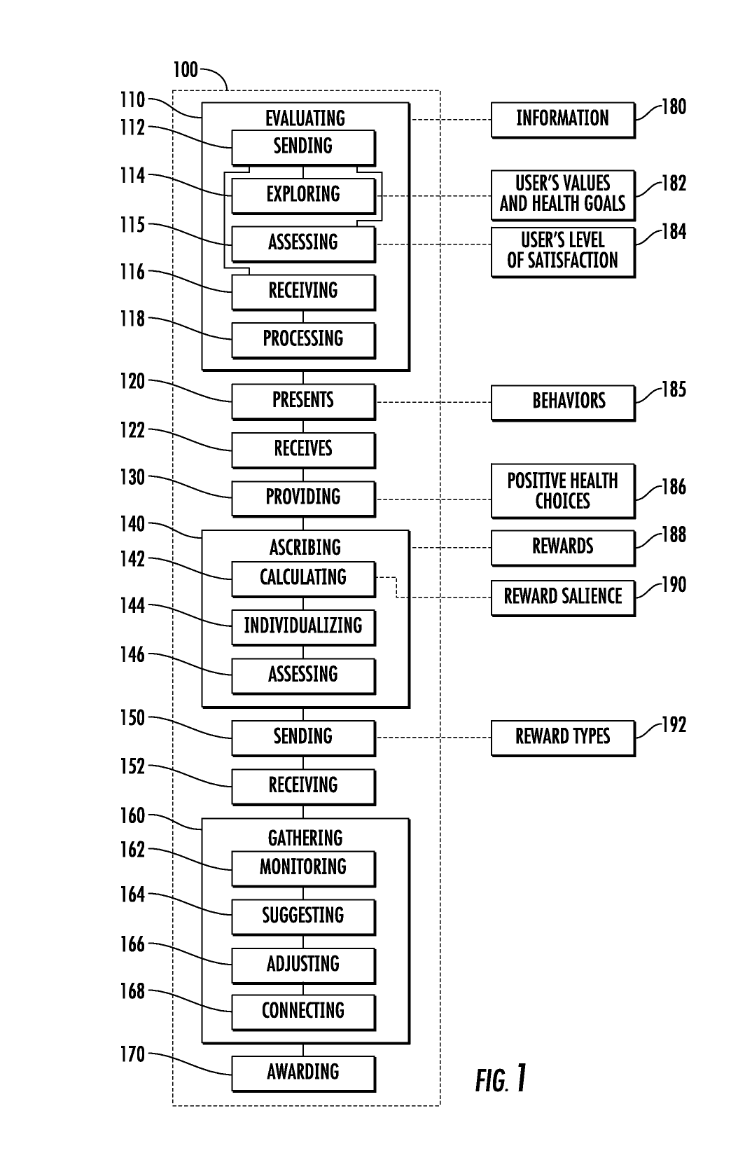

With reference to FIG. 1, presenting the inventive methods 100 from the perspective of the system 400, it has been found advantageous to have the present invention comprise the following steps. A system 400 evaluates 110 current health behaviors by sending 112 a request to a user device 410 for information 180 about a user's current or typical acts over the course of a day or week, and also what the user does not do in a typical day or week, or other time period; by receiving 116 information 180 from the user device 410, and then processing 118 the information 180. In some embodiments of the invention, the step of evaluating 110 may further comprise exploring 114 the values and health goals 182 of a user for the user's life, by requesting information related to such values and health goals 182 and receiving said information related to values and health goals 182. It has been found advantageous to have the method 100 step of evaluating 110 current health behaviors further comprise assessing 115 the user's level of satisfaction 184 with aspects of the user's life. By way of example, without limiting the foregoing, exploring 114 the values and health goals 182 may include presenting the user with questions about what the user wants to achieve, which may be cessation of smoking, a particular weight or body fat percentage, the ability to run a 5-kilometer race without pain or shortness of breath, or other goals, by sending 112 such requests to the user device 410. For further example, without limiting the foregoing, assessing 115 the user's level of satisfaction 184 may include asking the user, by sending 112 such requests to the user device 410, to rate their happiness with various aspects of their life by presenting the user with a series of questions about, by way of example, the user's health, education, income, social relationships, personal fulfillment, enjoyment, smiling, laughing, feeling well-rested, habits, level of energy, and general health and also the presence or absence of negative experiences and feelings such as pain, sadness, or worry. The preceding steps (112, 114, 115, 116, 118) of the method 100 that comprise evaluating 110 current health behaviors may be carried out by use of the plurality of central computing devices 450, and more specifically, in an evaluation module 452 if present in the embodiment of the system 400.

Under the inventive method 100, it has been found advantageous to have the system 400 present 120 to the user device 410 one or more unhealthy behaviors 185 to modify. The system 400 presents 120 the user device 410 with a list of behaviors 185 that the inventive system and methods can help the user to change, including but not limited to use of tobacco products, weight-related behaviors such as exercise and healthy eating, or excessive consumption of alcohol. After the system 400 presents 120 behaviors 185 to change, the system 400 receives 122 from the user device 410 the user's selections of a plurality of such behaviors 185 which the user desires to change.

The presently disclosed invention further comprises the system 400 providing 130 a plurality of positive health choices 186 to the user device 410, such that the user may learn of the positive health choices 186 and perform a plurality of the same. Such positive health choices 186 may include but are not limited to taking a walk, eating a healthy snack, doing a short aerobic exercise, or finding a friend to talk with. The positive health choices 186 may be selected from computer-readable instructions 490 as relevant to the user's values and health goals 182, such that the positive health choices 186 may help the user to change the desired behaviors 185. The preceding steps (120, 122, 130) of the method 100 may be carried out by use of the plurality of central computing devices 450, and more specifically, in a behavioral choice module 454 if present in the embodiment of the system 400.

Thereafter, the system 400 ascribes 140 levels of rewards 188 to positive health choices 186 carried out by the user. It has been found advantageous to have the step of ascribing 140 levels of rewards 188 comprise associating rewards 188 with a plurality of desired behaviors 185 and positive health choices 186, based on the relative healthfulness of the desired behaviors 185 and/or on the relative unhealthfulness of the undesired behaviors 185 which each desired behavior 185 is a possible replacement for. It has been found advantageous to have the step of ascribing 140 levels of rewards 188 further comprise calculating 142 reward salience 190 to prioritize positive health choices 186 that preclude, for said user, the most stimulating aspects of the unhealthy behavior 185, by providing levels of rewards 188 for changes to said most stimulating aspects of the unhealthy behavior 185 that are greater than levels of rewards 188 for changes to less stimulating aspects of the unhealthy behavior 185. Reward salience 190, in this context, means the relevance of the desired positive health choice 186 to a particular undesired unhealthy behavior 185. Calculating 142 reward salience 190, in the inventive method, entails setting the levels of rewards 188 relatively higher for positive health choices 186 that prevent or preclude the user from engaging in the least desirable (e.g., the most harmful) aspects of the undesired health behavior 185, while setting rewards 188 at relatively moderate or low levels for positive health choices 186 that i) do not prevent those least desirable particular undesired unhealthy behaviors 185, or ii) prevent or preclude other undesired unhealthy behaviors 185 which are not as greatly undesired.

The inventive method 100 can ascribe 140 levels of rewards 188 (also referred to as setting the “weighting” or amount of the reward 188) for a particular positive health choice 186 by factoring in how the behavior 185 was measured. For instance, without limiting the foregoing, manual entry of data on a positive behavior 185 or positive health choice 186 may be the least weighted means of entering data on the positive behavior 185 or positive health choice 186, while a means of entry of such data that is measured by a user device 410 that does not synchronize or share data with the inventive system 400 is weighted more strongly when the system 400 ascribes 140 levels of rewards 188. Data on a positive behavior 185 or a positive health choice 186 that is directly measured with a user device 410 that shares data with the inventive system 400, or that is directly synchronized from a social media 430 platform to the system 400, is most heavily weighted when the system 400 ascribes 140 levels of rewards 188. The inventive method 100 can also account for the increasing value of time spent pursuing positive behaviors 185 or positive health choices 186 up to some threshold or cut-off point, after which the positive benefit of that time levels off or declines. The weighting of the rewards 188, when the system 400 ascribes 140 levels of rewards 188, reflects this observation. For instance, without limiting the foregoing, if minutes 1 to 5 are each worth 1 “point” or quantum of rewards 188, minutes 6 to 10 may be worth 1.1 rewards 188 points, minutes 11 to 15 may be worth 1.25 rewards 188 points, minutes 16 to 20 may be worth 1.4 rewards 188 points, and so on, with each additional minute in a band of minutes worth additional rewards 188 points, until reaching 60 minutes (or any other quantifiable or appropriate threshold value), after which the rewards 188 points value of each additional minute can level off, i.e. stop increasing, or decrease.

Positive health choices 186 may include, but are not limited to, getting exercise or other outdoor activity, talking with friends, interacting with a embodiment of the inventive methods and systems, reading emails and weekly reports, “sharing” positive health choices 186 which the user has engaged in to a user's social media 430 accounts as posts, which may be tagged with data identifying such “shares” as related to the inventive method or a product or service associated with the inventive method, or making healthy purchases.

In some embodiments of the present invention, calculating 142 reward salience 190 may include consideration of one or more of: the relevance of the positive health choice 186 to the unhealthy behavior 185; the user's time spent on a positive health choice 186 to earn the rewards 188; how well the rewards 188 are working for the user, which the system 400 gauges after the user has been using the inventive method and systems for some period of time; how mutually exclusive the undesired behavior 185 and the positive health choice 186 are; and how challenging the positive health choice 186 is in relation to the undesired behavior 185, including but not limited to how hard it is to carry out the positive health choice 186, to get away from the unhealthy behavior 185. The step of ascribing 140 levels of rewards 188 may further comprise the system 400 individualizing 144 the reward salience 190 for a user, based on factors including but not limited to information 180 gathered from the user during the step of evaluating 110 current health behaviors, and on the results of gathering 160 information 180 on the user's behaviors and completion of positive health choices 186. In some embodiments of the present invention, individualizing 144 the reward salience 190 for a user may further comprise assessing 146 how efficiently the selected rewards 188 are working to get the user to make positive health choices 186. Efficiently, in this context, means how frequently a user chooses a positive health choice 186 and avoids an unhealthy behavior 185 when offered a given reward 188. The preceding steps (ascribing 140 levels of rewards 188, calculating 142 reward salience 190, individualizing 144 the reward salience 190, and assessing 146 how efficiently the selected rewards 188 are working) of the method 100 may be carried out by use of the plurality of central computing devices 450, and more specifically, in a reward computation module 456 if present in the embodiment of the system 400.

The inventive method further comprises the system 400 allowing the user to choose the specific form of the rewards 188, by sending 150 a plurality of reward types 192 to the user device 410, and receiving 152 from the user device 410 a plurality of the user's selections of reward types 192. It has been found advantageous to have the list of reward types 192 further comprise a list of partner programs of tangible rewards 188.

The presently disclosed invention further comprises the system 400 gathering 160 information 180 on the user's behaviors 185 and completion of positive health choices 186. In some embodiments of the present invention, gathering 160 information 180 on the user's behaviors 185 and completion of positive health choices 186 may include prompting the user, via the user device 410, to provide specific responses about the user's behaviors, by sending a specific request or requests to the user device 410. In other embodiments of the present invention, gathering 160 information 180 on the user's behaviors 185 and completion of positive health choices 186 may include prompting the user, by sending a specific request or requests to the user device 410, to read and/or review materials or presentations, and answer questions about such materials or presentations. In yet other embodiments, gathering 160 information 180 on the user's behaviors 185 and completion of positive health choices 186 may include gathering data on the user's behaviors 185 from partner applications, from social media 430, and/or from user devices 410 that are capable of sensing and recording information 180 relevant to health and positive health choices 186. Such user devices 410 include but are not limited to smartphones and other mobile user devices 410 that can sense and track information 180 including but not limited to location, velocity, steps taken, biometric measures such as heartrate, blood oxygenation, chemical or other analysis of breath exhalations, and more. Such user devices 410 may include those capable of tracking location and motion through use of global positioning satellites or communication with cellular radio towers or known wi-fi hotspots, use of accelerometers, or other means or instruments now known or later invented. By way of example, and without limiting the foregoing, such user devices 410 or partner applications may include but are not limited to mobile phones, smartphones, activity monitors or wearable devices such as the Fitbit, Jawbone, Nike band, Endomundo, MyFitnessPal, Moves, Runtracker, MapMyRide, or other types of user devices 410.

It has been found advantageous to have the method 100 further comprise monitoring 162 a user for completion of positive health choices 186, in which if a user is found to be not following the program implementing the present invention, i.e. is not making positive health choices 186 or otherwise modifying the user-chosen unhealthy behavior 185 or behaviors 185, the system 400 suggests 164 to the user, via the user device 410, that the rewards 188 program isn't working, and suggests 164 one or more other rewards 188 or positive health choices 186 for the user to try.

It has been found advantageous to have the inventive method 100 further factor in the results of the monitoring 162 of the user's completion of positive health choices 186 toward said desired alternative behavior 185, in order to efficiently ascribe 140 levels of rewards 188 appropriate to reinforce a positive health choice 186. The inventive method may, in an embodiment of the invention that has been found advantageous, further comprise the step of adjusting 166 the levels of rewards 188 to additionally incentivize the user to complete positive health choices 186 toward said desired alternative behavior 185. Adjusting 166 the levels of reward 188 can be used to offer the user greater incentive to make a positive health choice 186, or may be used to decrease the incentive of a positive health choice 186 if the level of reward 188 appears to be higher than required to incentivize the user to choose the particular positive health choice 186.

In still other embodiments of the present invention, the system 400 may connect 168 with one or more social media 430 platforms (which are defined for purposes of this disclosure as comprising any plurality of web sites or data repositories external to the system 400 and to the user device 410, and/or maintaining location awareness implemented with GPS, cellular tower location data, wi-fi hotspot location, or other means now known or later invented) and may use data derived from connecting 168 with the plurality of social media 430 platforms to suggest activities (including but not limited to positive health choices 186) or people in the area. The preceding steps (160, 162, 164, 166, 168) of the method 100 may be carried out by use of the plurality of central computing devices 450, and more specifically, in a data gathering module 458 if present in the embodiment of the system 400.

The inventive method 100 comprises the step of the system 400 awarding 170 rewards 188 to the user for each positive health choice 186. Awarding 170 may, in some embodiments of the invention, further factor in a user's completion of positive health choices 186, as found in the monitoring 162, and awarding 170 the user the rewards 188 associated with those positive health choices 186.

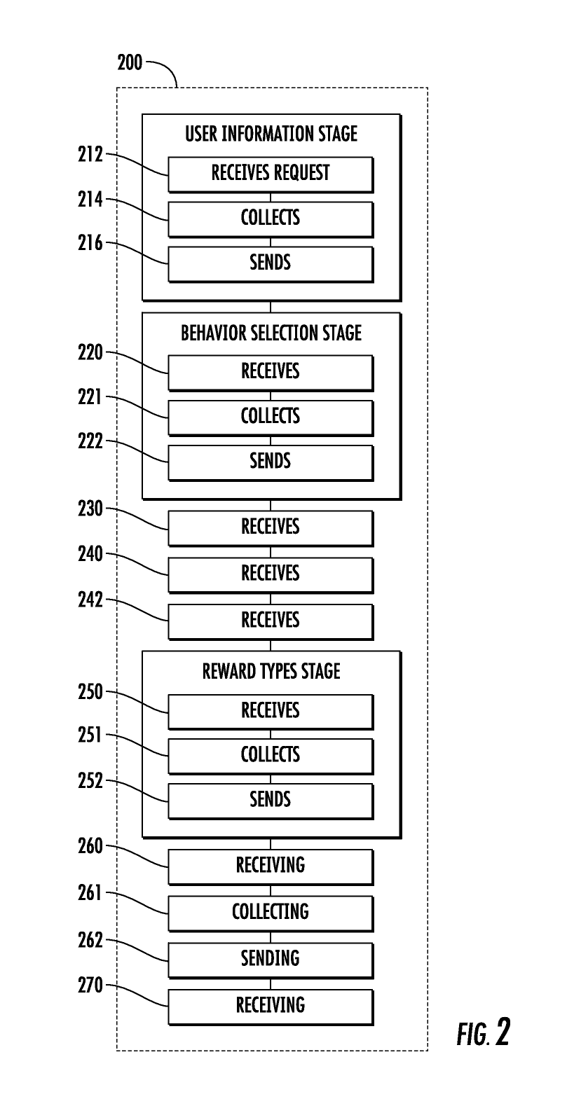

With reference to FIG. 2, presenting the inventive methods 200 from the perspective of a user device 410, it has been found advantageous to have the present invention comprise the following steps. The user device 410 receives 212 a request for information 180 from a system 400 about a user's current or typical acts over the course of a day or week, and also what the user does not do in a typical day or week, or other time period. The user device 410 collects 214 from a user information 180 responsive to such request, and later the user device 410 sends 216 the information 180 to the system 400. The preceding steps are referred to for convenience in FIG. 2 as the “user information stage.”

The user device 410 later, in what is referred to for convenience in FIG. 2 as the “behavior selection stage,” receives 220 from the system 400 one or more unhealthy behaviors 185 to modify. The user device 410 collects 221 from the user information 180 responsive to the list of unhealthy behaviors 185 to modify, including but not limited to the user's selections of a plurality of unhealthy behaviors 185 the user desires to modify. Later, the user device 410 sends 222 the user's selections of a plurality of unhealthy behaviors 185 to the system 400.

At a later time, the user device 410 receives 230 from the system 400 a plurality of positive health choices 186. It has been found advantageous to have the user device 410 receive 240 from the system 400 certain ascribed levels of rewards 188, so that the user may understand how rewards 188 relate to positive health choices 186 and see the incentives for making positive health choices 186. In some embodiments of the present invention, the user device 410 receives 242 from the system 400 certain calculated values for reward salience 190, such that the user may understand how rewards 188 relate to positive health choices 186 and see the incentives for making positive health choices 186 that prevent or preclude the user from engaging in the least desirable health behaviors 185.

The user device 410 later, in what is referred to for convenience in FIG. 2 as the “reward types stage,” receives 250 from the system 400 a list of reward types 192. The user device 410 collects 251 from the user a plurality of the user's selections of reward types 192. Later, the user device 410 sends 252 the user's selections of a plurality of reward types 192 to the system 400.

The user device 410 receives 260 a request from the system 400 for information 180 on the user's behaviors 185 and completion of positive health choices 186. In some embodiments of the present invention, this may comprise a request for input actionable by the user; in such embodiments the user device 410 collects 261 the information 180 from the user and later sends 262 the information to the system 400. In other embodiments, the request received 260 by the user device 410 may be to a record of data stored in the user device 410 or in an external database accessed by the user device 410, such that the user device 410 can synchronize information 180 on the user's behaviors 185 and completion of positive health choices 186 to the system 400 without direct or active involvement of the user. In such embodiments, the user device 410 sends 262 the information 180 from the user to the system 400. At a later time, in some embodiments of the present invention, the user device 410 receives 270 from the system 400 a plurality of rewards 188 for positive health choices 186, which may be rewards 188, or a notification of sending of the user's chosen form of tangible rewards.

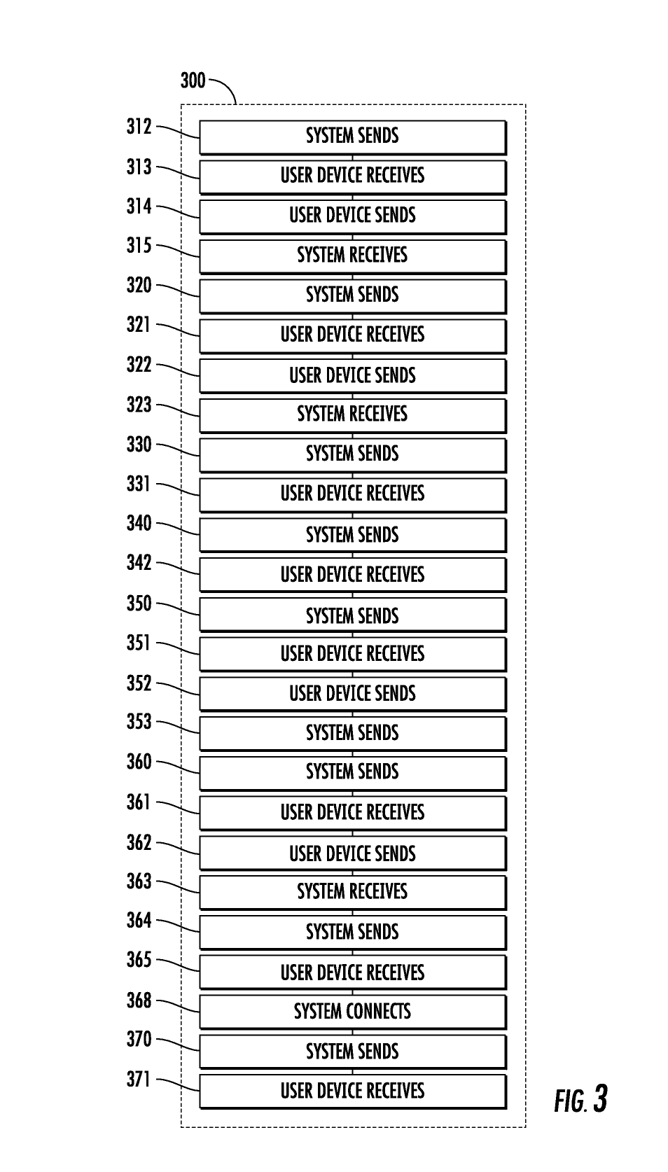

With reference to FIG. 3, presenting the inventive methods 300 from the perspective of a third party external to both the system 400 and the user device 410, it has been found advantageous to have the present invention comprise the following steps. The system sends 312 a request to a user device 410 for information 180 about a user's current or typical acts over the course of a day or week, and also what the user does not do in a typical day or week, or other time period. The user device 410 receives 313 that request, and later sends 314 a response to the requested information 180 to the system 400, which receives 315 the requested information 180.

The system sends 320 to the user device 410 one or more unhealthy behaviors 185 to modify. The user device 410 receives 321 that plurality of unhealthy behaviors 185, and later sends 322 the user's selections of a plurality of such behaviors 185, which the user desires to change, to the system 400, which receives 323 the user's selections of a plurality of such behaviors 185. Thereafter, the system 400 sends 330 to the user device 410 a plurality of positive health choices 186. The user device 410 receives 331 the plurality of positive health choices 186. Later, the system 400 sends 340 levels of rewards 188 ascribed to positive health choices 186, and reward salience 190, to the user device 410. The user device 410 receives 342 the levels of rewards 188 and reward salience 190.

Thereafter, the system sends 350 a plurality of reward types 192 to the user device 410. The user device 410 receives 351 the plurality of reward types 192, and later sends 352 a plurality of the user's selections of reward types 192 to the system 400, which receives 353 the plurality of the user's selections of reward types 192.

At a later time, the system sends 360 a request for information 180 on the user's behaviors 185 and completion of positive health choices 186. The system sends 360 such a request to an external device, which may be the user device 410 or a social media 430 platform, or other device. The external device receives 361 the request for information 180 on the user's behaviors 185 and completion of positive health choices 186. Later, the external device (the user device 410, or the social media 430 platform, or another external device), sends 362 data responsive to the request for information 180 on the user's behaviors 185 and completion of positive health choices 186 to the system 400, which receives 363 data responsive to the request for information 180 on the user's behaviors 185 and completion of positive health choices 186.

In some embodiments of the present invention, the system 400 sends 364 to the user device 410 one or more other rewards 188 or positive health choices 186 for the user to try. The user device 410 receives 365 the one or more other rewards 188 or positive health choices 186 for the user to try. In other embodiments of the present invention, the system 400 connects 368 with one or more social media 430 platforms. In other embodiments of the present invention, the system 400 sends 370 a notification of award of rewards 188, which notification may comprise a reward 188, to the user device 410. The user device 410 receives 371 the notification of award of rewards 188.

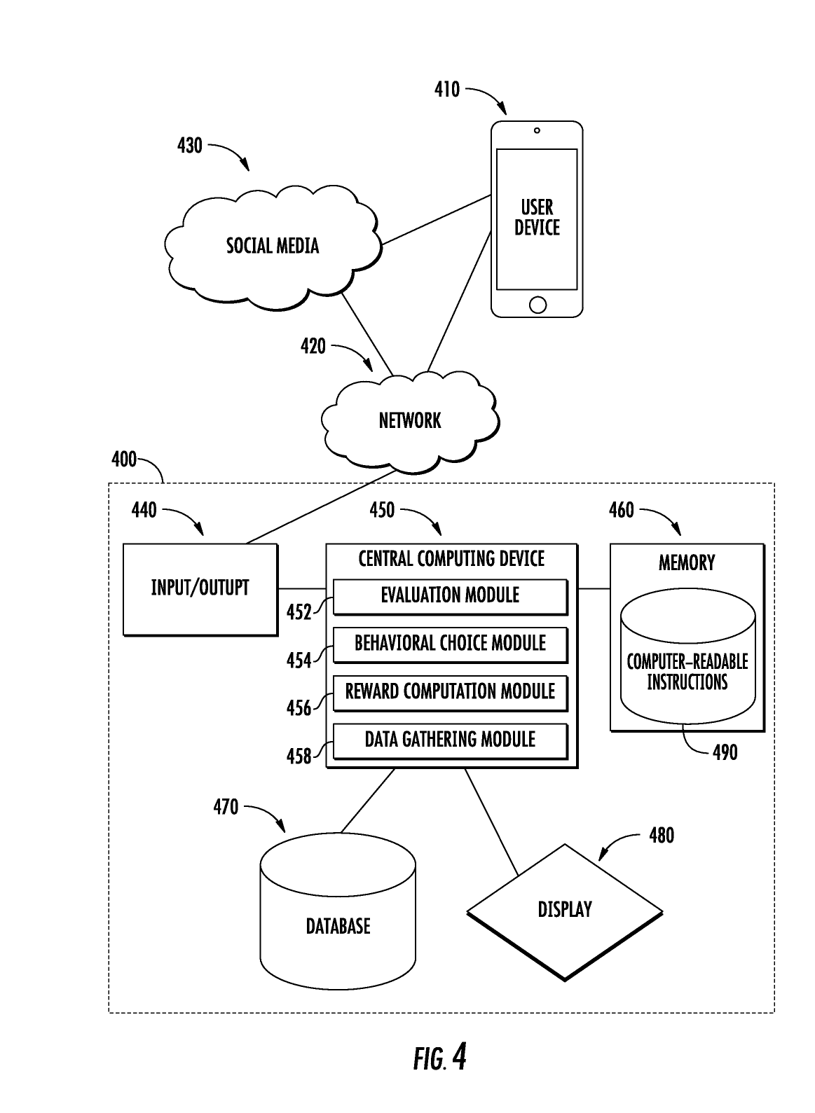

With reference to FIG. 4, the method 100 of the present invention may be carried out on an inventive system 400 comprising a plurality of central computing devices 450, a plurality of memory units 460 which may store a plurality of computer-readable instructions 490, a plurality of input and output modules 440 for communication, a plurality of databases 470, the foregoing components being communicably connected, and optionally a plurality of displays, and the ability to communicate with a plurality of user devices 410, including receiving information from such user devices 410, sending information to such user devices 410, and optionally monitoring and processing location data and other data from such user devices 410. It has been found advantageous to have the inventive system 400 comprise a plurality of central computing devices 450, a plurality of input/output 440 modules, a computer-readable memory 460 comprising or storing computer-readable instructions 490, and a database 470. In some embodiments of the present invention, the system further comprises a display 480. It has been found advantageous to have the plurality of central computing devices 450 further comprise one or more of each of: an evaluation module 452, a behavioral choice module 454, a reward computation module 456, and a data-gathering module 458. It has further been found advantageous to have the system 400 communicate, using the plurality of input/output 440 modules and a plurality of external networks 420, with a plurality of user devices 410, and to have the system 400 communicate, using the plurality of input/output 440 modules and a plurality of external networks 420, with social media 430 platforms or related external databases. In some embodiments of the present invention, the computer-readable instructions 490 comprise instructions for carrying out methods for incentivizing healthy behavioral changes with evidence-based techniques and tangible rewards.

When interacting with the inventive system, a user may input information 180 on the user's behaviors and completion of positive health choices 186, using the user device 410, and the user device 410 may, in embodiments of the invention that have been found advantageous, gather information 180 automatically and/or while operating in the background on the user device 410. The user device 410 transmits the information 180 via the network 420 and the input/output 440 to the central computing device 450. The central computing device 450 can evaluate 110 the user's health behaviors, and in embodiments of the present invention that have been found advantageous, the central computing device 450 additionally retrieves questions and data from the database 470 to enable the central computing device 450 to interact with the user on the user device 410, via the input/output 440 and the network 420, so that the central computing device 450 can carry out the steps of exploring 114 the user's values and health goals, and assessing 115 the user's level of satisfaction with aspects of the user's life. The central computing device 450 stores information 180 in the memory 460 as needed, to process the information 180 in carrying out the steps of exploring 114 the user's values and health goals 182, and assessing 115 the user's level of satisfaction 184 with aspects of the user's life. The central computing device 450 stores the information 180, as it is received from the user device 410 via the network 420 and the input/output 440, in the database 470 and also stores the results of the processing of that information 180 in the database 470.

Based on those results, the central computing device 450 transmits to the user device 410, via the input/output 440 and the network 420, one or more requirements 120 that the user choose one or more unhealthy behaviors to modify. The user device 410 communicates the user's choice or choices via the network 420 and the input/output 440 to the central computing device 450. The central computing device 450 then searches the database 470 for positive health choices 186 related to the user's choices of unhealthy behaviors to modify, finds relevant positive health choices 186, provides 130 those positive health choices 186 to the user, and with those positive health choices 186, the central computing device 450 finds in the database 470 data allowing the central computing device 450 to ascribe 140 of levels of rewards 188 for the positive health choices 186 calculated to incentivize the user to adopt the positive health behavior or slow or cease the unhealthy behavior or behaviors which the user selected. The central computing device 450 transmits options for forms of rewards 188 to the user device 410 via the input/output 440 and the network 420, from which the user is permitted 150 to choose the specific form of rewards 188 which the user prefers. The central computing device 450 stores the user's choice of form of rewards 188 in the database 470 with the records related to that user. It has been found advantageous to have the central computing device 450 iteratively calculate 142 reward salience 190 and individualize 144 the reward salience 190, based on repeated communication of information 180 from the user, both actively and by the user device 410 automatically or in the background, such information 180 being used by the central computing device 450 to calculate whether the form and levels of rewards 188 are adequately incentivizing, or over-incentivizing, the user to take the desired positive health choices 186 to change or mitigate the user's chosen unhealthy behaviors. In some embodiments of the present invention, some such positive health choices 186 may include the user communicating acts, including other positive health choices 186, to one or more social media 430 platforms from a user device 410 via the network 420. It has been found advantageous to have the central computing device 450 immediately communicate the calculated values for reward salience 190 and individualized 144 reward salience 190 via the input/output 440 and the network 420 to the user device 410 or to an instance of the inventive method 100 running on a user device 410. In other embodiments of the present invention, the central computing device 450 may communicate such calculated information to the user device 410 or to an instance of the inventive method 100 running on a user device 410 at a scheduled later time, or on demand.

A user can, using a user device 410, send information to the central computing device 450, via the network 420 and the input/output 440, on the user's selection of the specific form of the rewards 188, which the central computing device 450 stores in the database 470 in records associated with the user. As the user uses the present invention and goes about activities, the user device 410 stores and transmits data via the network 420 and the input/output 440 to central computing device 450 on activities of the user. The central computing device 450 gathers 160 this data, processes it in the memory 460, and stores it in the database 470 records of the information 180 associated with the user.

It has been found advantageous to have the central computing device 450 compare the information 180 on the monitored 162 activities of the user with the positive health choices 186 that were provided by the inventive system to the user. The central computing device 450 may, in an embodiment of the invention that has been found advantageous, compute adjustments 166 to the levels of reward 188 associated with positive health choices 186 for a user, store those adjusted values of reward 188 for positive health choices 186 in the database 470, and communicate the same to the user device 410 via the input/output 440 and the network 420. The central computing device 450 monitors 162 the completion of positive health choices 186 by the user, based on the continuing stream of information 180 about the user's ongoing acts and activities gathered 160 from the user device 410. The central computing device 450 awards 170 points to the user, communicating the points to the user via the user device 410 or other means, in the form of rewards 188 chosen by the user. At any point in the functioning of the inventive system described above, an administrator may interact with the inventive system, including any one or more user devices 410, the central computing device 450, the memory 460, and/or the database 470, via the input/output 440 directly with or without use of the network 420, and/or by use of a display 480 engaged directly with the central computing device 450.

The various modules and/or functions described above may be implemented by computer-executable instructions, such as program modules, executed by a conventional computer. Generally, program modules include routines, programs, objects, components, data structures, etc. that performs particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device 450 may comprise or consist of a general-purpose computing device in the form of a computer including a processing unit, a system memory, and a system bus that couples various system components including the system memory to the processing unit. Computers typically include a variety of computer-readable media that can form part of the system memory 460 and be read by the processing unit. By way of example, and not limitation, computer readable media may comprise computer storage media and communication media. The system memory 460 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain embodiments of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, I claim:

1. A method, stored in computer-readable media, for incentivizing healthy behavioral changes with evidence-based techniques and tangible rewards, the method comprising:
a system evaluates current health behaviors by sending a request to a user device for information;
the system receives information from the user device;
the system processes the information;
the system presents to the user device one or more unhealthy behaviors to modify;
the system receives from the user device a user's selections of a plurality of such behaviors;
the system provides a plurality of positive health choices to the user device;
the system ascribes levels of rewards to positive health choices;
the system sending a plurality of reward types to the user device;
the system receives from the user device a plurality of the user's selections of reward types;
the system gathering information on the user's behaviors and completion of positive health choices;
the system adjusts the levels of reward; and
the system awards rewards.

2. The method of claim 1, in which the step of the system evaluating current health behaviors further comprises:
the system exploring the values and health goals of a user.

3. The method of claim 1, in which the step of the system evaluating current health behaviors further comprises:
the system assessing the user's level of satisfaction with aspects of the user's life.

4. The method of claim 1, in which the step of the system ascribing levels of rewards further comprises:
the system calculating reward salience.

5. The method of claim 1, in which the step of the system ascribing levels of rewards further comprises:
the system setting the amount of the reward by factoring in how the behavior was measured.

6. The method of claim 1, in which the step of the system ascribing levels of rewards further comprises:
the system accounting for the increasing value of time spent up to some cut-off point.

7. The method of claim 1, in which the step of the system ascribing levels of rewards further comprises:
the system individualizing the reward salience for a user.

8. The method of claim 7, in which the step of the system individualizing the reward salience for the user further comprises:
the system assessing how efficiently the selected rewards are working to get the user to make positive health choices.

9. The method of claim 1, in which the step of the system gathering information on the user's behaviors and completion of positive health choices further comprises:
the system monitoring the user for completion of positive health choices.

10. The method of claim 9, in which the step of the system gathering information on the user's behaviors and completion of positive health choices further comprises:
the system suggests one or more other rewards or positive health choices.

11. The method of claim 1, in which the method further comprises the step of the system connecting with one or more social media platforms.

12. A method, stored in computer-readable media, for incentivizing healthy behavioral changes with evidence-based techniques and tangible rewards, the method comprising:
a user device receives a request for information from a system;
the user device collects from a user information;
the user device sends the information to the system;
the user device receives from the system one or more unhealthy behaviors to modify;
the user device collects from the user information;
the user device sends the user's selections of a plurality of unhealthy behaviors to the system;
the user device receives from the system a plurality of positive health choices;
the user device receives from the system a list of reward types;
the user device collects from the user a plurality of the user's selections of reward types;
the user device sends the user's selections of a plurality of reward types to the system;
the user device receives a request from the system for information on the user's behaviors and completion of positive health choices; and
the user device sends the information on the user's behaviors and completion of positive health choices to the system.

13. The method of claim 12, in which the method further comprises the step of the user device receiving from the system certain ascribed levels of rewards.

14. The method of claim 12, in which the method further comprises the step of the user device receiving from the system certain calculated values for reward salience.

15. The method of claim 12, in which the method further comprises the step of the user device collecting information on the user's behaviors and completion of positive health choices from the user.

16. The method of claim 12, in which the method further comprises the step of the user device receiving from the system a plurality of rewards.

17. A method, stored in computer-readable media, for incentivizing healthy behavioral changes with evidence-based techniques and tangible rewards, the method comprising:
a system sends a request to a user device for information about a user;
the user device receives that request;
the user device sends a response to the requested information to the system;
the system receives the requested information;
the system sends to the user device one or more unhealthy behaviors to modify;
the user device receives that plurality of unhealthy behaviors;
the user device sends the user's selections of a plurality of such behaviors to the system;
the system receives the user's selections of a plurality of such behaviors;
the system sends to the user device a plurality of positive health choices;
the user device receives the plurality of positive health choices;
the system sends levels of rewards and reward salience to the user device;
the user device receives the levels of rewards and reward salience;
the system sends a plurality of reward types to the user device;
the user device receives the plurality of reward types;
the user device sends a plurality of the user's selections of reward types to the system;
the system receives the plurality of the user's selections of reward types;
the system sends a request for information on the user's behaviors and completion of positive health choices to an external device;
the external device receives the request for information on the user's behaviors and completion of positive health choices;
the external device sends data responsive to the request for information on the user's behaviors and completion of positive health choices to the system; and
the system receives data responsive to the request for information on the user's behaviors and completion of positive health choices.

18. The method of claim 17, in which the external device is the user device.

19. The method of claim 17, in which the external device is a social media platform.

20. The method of claim 17, in which the method further comprises the steps of:
the system sends to the user device one or more other rewards or positive health choices for the user to try; and
the user device receives the one or more other rewards or positive health choices.

21. The method of claim 17, in which the method further comprises the step of the system connecting with one or more social media platforms.

22. The method of claim 17, in which the method further comprises the steps of:
the system sends a notification of award of rewards to the user device; and
the user device receives the notification of award of rewards.

23. A system of communicably connected components for incentivizing healthy behavioral changes with evidence-based techniques and tangible rewards, the system comprising:
a plurality of central computing devices;
a plurality of memory units containing a plurality of computer-readable instructions;
a plurality of input and output modules; and
a plurality of databases.

24. The system of claim 23, in which the plurality of memory units store a plurality of computer-readable instructions.

25. The system of claim 23, in which the plurality of computer-readable instructions comprise instructions for carrying out methods for incentivizing healthy behavioral changes with evidence-based techniques and tangible rewards.

26. The system of claim 23, in which the system further comprises a plurality of displays.

27. The system of claim 23, in which the plurality of central computing devices further comprises an evaluation module.

28. The system of claim 23, in which the plurality of central computing devices further comprises a behavioral choice module.

29. The system of claim 23, in which the plurality of central computing devices further comprises a reward computation module.

30. The system of claim 23, in which the plurality of central computing devices further comprises a data-gathering module.

31. The system of claim 23, in which the system communicates, using the plurality of input/output modules and a plurality of external networks, with a plurality of user devices.

32. The system of claim 23, in which the system communicates, using the plurality of input/output modules and a plurality of external networks, with social media platforms or related external databases.

33. The system of claim 23, in which the system communicates, using the plurality of input/output modules and a plurality of external networks, with external databases.
